(19) United States
(12) Patent Application Publication
(10) Pub. No.: US 2026/0091482 A1
(43) Pub. Date: Apr. 2, 2026

(54) SYSTEM AND METHOD FOR WEARABLE-ROBOTIC DEVICE GAMING

(71) Applicant: Futronics (NA) Corporation, Pasadena, CA (US)

(72) Inventors: Luis Alfredo Mateos GUZMAN, Pasadena, CA (US); Fangyun ZHAO, Pasadena, CA (US); Weide ZHANG, Pasadena, CA (US); Yunfei GUO, Pasadena, CA (US); Fulan LI, Pasadena, CA (US); Wenda XU, Pasadena, CA (US); Chengkun ZHANG, Pasadena, CA (US); Huan TAN, Pasadena, CA (US)

(73) Assignee: Futronics (NA) Corporation, Pasadena, CA (US)

(21) Appl. No.: 18/898,896

(22) Filed: Sep. 27, 2024

(51) Int. Cl. B25J 9/00; B25J 9/16; B25J 13/08

(52) U.S. Cl. CPC B25J 9/0006; B25J 9/161; B25J 9/1679; B25J 13/085

(57) ABSTRACT

According to one aspect of the present disclosure, a method of virtual-reality (VR) gaming is provided. The method may include initiating, by a processor, a virtual experience associated with a wearable-robotic device coupled to a user. The virtual experience may include an avatar associated with the user. The method may include determining, by the processor, an interaction with a virtual object by the avatar causes a change in one or more of a weight or a shape of the virtual object. The method may include causing, by the processor, the wearable-robotic device to output a physical-feedback response corresponding to the change in the one or more of the weight or the shape of the virtual object.

### TECHNICAL FIELD

The present disclosure relates to systems and methods for wearable-robotic device gaming.

### BACKGROUND

Upper limb exoskeletons are wearable-robotic devices that assist, support, or supplement a user's upper limbs. Traditionally, their applications have focused on rehabilitation for individuals with neurological conditions (e.g., stroke, spinal cord, injury, etc.) or for industrial use to reduce worker fatigue and injury.

Recently, there is a growing interest in using upper limb exoskeletons for rehabilitation gaming purposes. This combines the potential benefits of exoskeletons with the engaging and motivating nature of video games. For instance, games can make physical therapy exercises more engaging and motivating, leading to improved patient adherence and potentially faster recovery times. Thus, exoskeletons have recently been used in various virtual-experience systems (e.g., video game systems, virtual reality (VR) game systems, augmented reality (AR) game systems, etc.) to create a more interactive rehabilitation experience.

A user's interaction with virtual objects in the virtual experience via the exoskeleton is handled by an exoskeleton controller. In some instances, the virtual objects are mass-less objects and the exoskeleton controller only considers the positional movements from the exoskeleton joint. This creates a point-to-point movement for the rehabilitation session. There are other systems that consider a deadweight of a virtual object. In these systems, exoskeletons may provide a physical-feedback response that corresponds to the deadweight of the virtual object when a user performs mobility tasks, e.g., such as moving a virtual object. However, exoskeleton systems that only allow engagement with mass-less or static-weight virtual objects are unable to provide a full range of real-world mobility tasks.

Thus, there exists an unmet need for an exoskeleton system that provides a more robust rehabilitation experience.

### SUMMARY

According to one aspect of the present disclosure, a method of virtual-reality (VR) gaming is provided. The method may include initiating, by a processor, a virtual experience associated with a wearable-robotic device coupled to a user. The virtual experience may include an avatar associated with the user. The method may include determining, by the processor, an interaction with a virtual object by the avatar causes a change in one or more of a weight or a shape of the virtual object. The method may include causing, by the processor, the wearable-robotic device to output a physical-feedback response corresponding to the change in the one or more of the weight or the shape of the virtual object.

According to another aspect of the present disclosure, an apparatus for VR gaming is provided. The apparatus may include a wearable-robotic device coupled to a user. The apparatus may include a processor. The processor may be configured to initiate a virtual experience associated with the wearable-robotic device, the virtual experience including an avatar associated with the user. The processor may be configured to determine an interaction with a virtual object by the avatar causes a change in one or more of a weight or a shape of the virtual object. The processor may be configured to cause the wearable-robotic device to output a physical-feedback response corresponding to the change in the one or more of the weight or the shape of the virtual object.

According to a further aspect of the present disclosure, a non-transitory computer-readable medium storing instructions is provided. The instructions, which when executed by a processor, may cause the processor to initiate a virtual experience associated with a wearable-robotic device. The virtual experience may include an avatar associated with a user. The instructions, which when executed by a processor, may cause the processor to determine an interaction with a virtual object by the avatar causes a change in one or more of a weight or a shape of the virtual object. The instructions, which when executed by a processor, may cause the processor to cause the wearable-robotic device to output a physical-feedback response corresponding to the change in the one or more of the weight or the shape of the virtual object

It is to be understood that both the foregoing general description and the following detailed description are exemplary and explanatory only and are not restrictive of the invention, as claimed.

### BRIEF DESCRIPTION OF THE DRAWINGS

FIG. 1 illustrates an exemplary exoskeleton system with a wearable-robotic device, according to embodiments of the disclosure.

FIG. 2 illustrates a block diagram of an exemplary exoskeleton controller, illustrated in FIG. 1, according to embodiments of the disclosure.

FIG. 3 illustrates an example depiction of a user engaged with the exoskeleton system of FIG. 1, according to embodiments of the disclosure.

FIG. 4 is a flowchart of an exemplary method of VR gaming performed by an exoskeleton system, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

The proper functioning of the limbs of the human body plays a fundamental role in one's health. When limbs are temporarily or permanently affected, significant motor difficulties appear. In such cases, physical rehabilitation may be prescribed as part of a course of treatment.

Exoskeletons for rehabilitation gaming purposes combine the potential benefits of exoskeletons with the engaging and motivating nature of video games. Within a rehabilitation game, virtual objects are simulated with real-life variables, e.g., such as gravity, forces, and particle systems to mimic particles of water, sand, etc. An exoskeleton controller may be used to link all the virtual experience variables to provide a realistic simulation and physical-feedback response to the user.

However, when the weight and/or shape of a virtual object is varying (e.g., pouring water from a glass, drinking water from a glass, playing with sand, etc.), simulating the forces applied to the wearable-robotic device is challenging. The exoskeleton controller is required not only to understand the position of the exoskeleton and the virtual object, but also to add dynamics to the virtual objects to reflect those forces in reality.

The exoskeleton controller may determine the position of the exoskeleton within the virtual experience based on position signals output from encoder sensors located at each joint of the wearable-robotic device. A torque sensor may be integrated onto each joint of the exoskeleton to read the force it is applying as well as the force received from an external input, such as the patient's arm force. By fusing the position and torque variables, the exoskeleton controller is able to control the movement of the exoskeleton and understand the forces affecting it.

In some implementations, the exoskeleton controller may use the position (or distance) and torque signals to determine a change in the weight and/or shape of a virtual object, and cause the exoskeleton to output a corresponding physical-feedback response.

For instance, if a user lifts a simulated jar of water, then the exoskeleton controller can determine the physical-feedback response that corresponds to the initial amount of water in the jar. Then, if the user starts pouring the simulated water from the jar, the exoskeleton controller can determine when water will begin falling from the jar by comparing the angular degree calculated based on the torque signals with an angular degree threshold. Once the angular degree threshold is met, the change in the weight of the virtual jar can be calculated based on the position signals and the torque signals. Then, the exoskeleton controller may cause the exoskeleton to output an updated physical-feedback response that corresponds to the current amount of water left in the jar.

In another example, if a user picks up a handful of virtual sand, then the exoskeleton controller can determine how much sand was picked up based on the signals output by the torque and encoder sensors. Then, if the user turns their hand such that grains of virtual sand begin falling from their grasp, the exoskeleton controller can determine when sand will begin leaving the user's hand based on an angular degree calculated based on the torque signals. Once the angular degree threshold is met, the change in the weight and shape of the virtual sand can be calculated based on the position signals and the torque signals. In so doing, the exoskeleton controller may cause the exoskeleton to output a physical-feedback response corresponding to the change in the weight of the sand in the user's hand.

In yet a further example, if a user picks up a virtual deformable object (such as a virtual therapy ball), then the exoskeleton controller can determine the weight distribution of the ball in the user's grasp based on position and torque signals. Then, if the user squeezes the deformable object, the exoskeleton controller can determine a change in shape (change in weight distribution) of the ball based on the torque signals. Once a force threshold is met, the change in the shape can be calculated based on the position signals and the torque signals. In so doing, the exoskeleton controller may cause the exoskeleton to output a physical-feedback response corresponding to a different weight distribution of the deformable object in the user's hand.

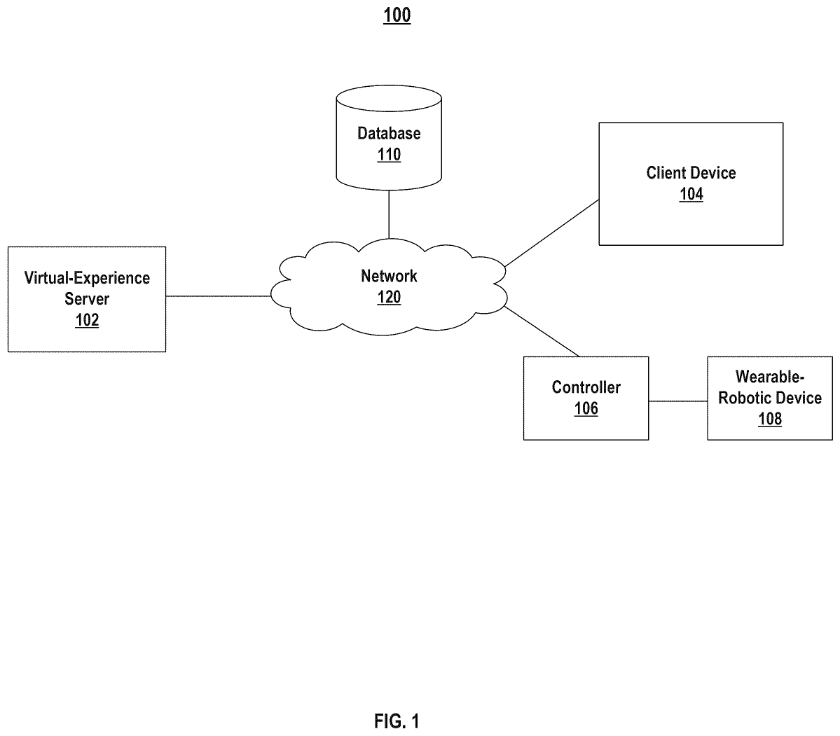

Using these and other techniques, the exoskeleton system of the present disclosure provides mobility tasks that improve user rehabilitation by training with virtual objects with deformable and/or changing weight. Additional details of the exemplary virtual-experience system and its operations are provided below in connection with FIGS. 1-4.

FIG. 1 illustrates an exemplary exoskeleton system 100 (referred to as “system 100” hereafter), according to embodiments of the disclosure. As shown in FIG. 1, system 100 may include a virtual-experience server 102, a client device 104, a network 120, a wearable-robotic controller 106 (hereinafter “controller 106”), and a wearable-robotic device 108.

Virtual-experience server 102 may maintain, among others, one or more virtual experiences related to exoskeleton gaming. A user (e.g., player, patient, clinician, etc.) may be able to select from among the virtual experiences maintained by virtual-experience server 102 via client device 104 or another device. Information related to a selected virtual experience, e.g., such as the initial weight of a jar of water, an amount of water in the glass, weight of sand per volume, the weight, shape, and deformation characteristics of a virtual deformable object, etc., may be provided to client device 104 and controller 106. For example, controller 106 may cause wearable-robotic device 108 to output a feedback response corresponding the initial weight, initial shape, change in weight, or change in shape of the virtual object, depending on the user's actions.

Virtual-experience server 102 may include a server with one or more computing devices (e.g., a cloud computing device, a rackmount server, a server computer, a cluster of servers, virtual server, etc.). In some implementations, virtual-experience server 102 may be a single server, or any combination of a plurality of servers, network devices, etc. Virtual-experience server 102 may include one or more computing devices (e.g., a rackmount server, a router computer, a server computer, a personal computer, a mainframe computer, a laptop computer, a tablet computer, a desktop computer, etc.), data stores (e.g., hard disks, memories, databased, etc.), networks, software components, and/or hardware components that may perform operations related to virtual-experience simulation.

In some implementations, virtual experiences may include two-dimensional (2D) games, three-dimensional (3D) games, VR games, or augmented reality (AR) games, for example. The virtual experiences may be designed to provide virtual mobility tasks for rehabilitation via wearable-robotic device 108. Non-limiting examples of these types of virtual experiences may include rehabilitation games, strengthening games, leisure games, etc.

Network 120 may facilitate communication between various devices in system 100. For instance, network 120 may include a Wireless Local Area Network (WLAN), a Wide Area Network (WAN), wireless networks such as radio waves, a cellular network, and/or a local or short-range wireless network (e.g., Bluetooth™), or other communication networks.

Client device 104 may include computing devices such as personal computer (PCs), mobile devices (e.g., laptops, mobile phones, smart phones, tablet computers, notebook computers, etc.), televisions, gaming consoles, etc. The virtual experience may be rendered for user interaction at client device 104. Within a virtual experience, a user may interact with a virtual object via an avatar and experience a feedback response via wearable-robotic device 108 when a change in weight and/or shape of the virtual object occurs.

Wearable-robotic device 108 may be designed for, among others, motor rehabilitation of impaired limbs or leisure gaming. In the rehabilitation scenario, wearable-robotic device 108 may support the clinician in providing rehabilitative exercises. The advantage wearable-robotic device 108 brings with respect to traditional therapy lies in the larger number of repetitions that can be performed in a session, the possibility of objectively quantifying the user's performance, a reduction in the clinician's physical burden, and the possibility to monitor the user's involvement in the training. This makes it possible to increase the virtual weight of objects a user interacts with in the virtual experience, personalize the intensity of the training, and stimulate the participation of the user, which are all key factors in motor re-learning.

Wearable-robotic device 108 (also referred to herein as “exoskeleton”) may include, e.g., an upper-limb exoskeleton worn on a user's arm or hand and/or a lower-limb exoskeleton worn on a user's leg or foot. Wearable-robotic device 108 may be composed of rigid or flexible links that are attached to the user's limbs, and actuators, which exert torques at the joint level. An encoder sensor and a torque sensor may be coupled at one or more joints. Both the encoder sensors and the torque sensors may send respective signals to controller 106. The encoder sensor may send signals related to the position of wearable-robotic device 108 in the virtual experience. The torque sensors may generate a set of torque signals when a user interacts with a virtual object using wearable-robotic device 108.

Controller 106 may determine an angular degree of the virtual object based on the torque signals. The angular degree may relate to the turning of the hand or other gestures made by the user when interacting with a virtual object. When the angular degree reaches a threshold, e.g., such as when the user turns a glass of water so that water begins pouring out, controller 106 may determine a change in the weight or the shape of the virtual object based on the position signals from the encoder sensor and the torque signals from the torque sensors. Based on the determined change, controller 106 may cause wearable-robotic device 108 to output a corresponding feedback response, which is received by the user. For instance, the user may experience a decrease in weight of a virtual glass of water or the change in the shape (e.g., weight distribution) of a deformable object through a pressure feedback.

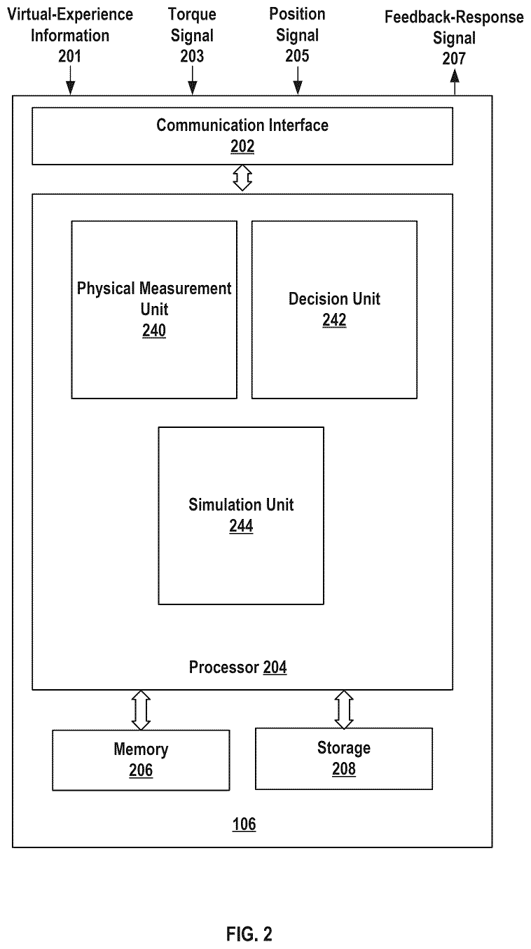

Additional details of controller 106 and its exemplary operations are provided below in connection with FIG. 2.

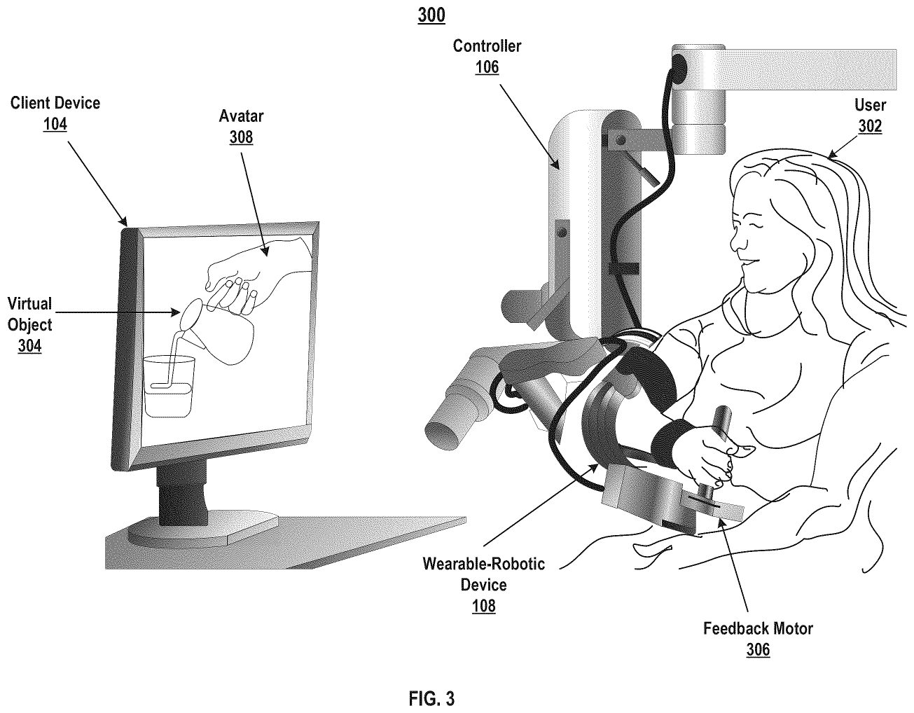

FIG. 2 illustrates a block diagram of controller 106, according to embodiments of the disclosure. FIG. 3 illustrates an example depiction 300 of a user 302 engaged with the exoskeleton system 100 of FIG. 1, according to embodiments of the disclosure. FIGS. 2 and 3 will be described together.

In some embodiments, as shown in FIG. 2, controller 106 may include a communication interface 202, a processor 204, a memory 206, and a storage 208. In some embodiments, controller 106 may include different modules in a single device, such as an integrated circuit (IC) chip (implemented as an application-specific integrated circuit (ASIC) or a field-programmable gate array (FPGA)), or separate devices with dedicated functions. In some embodiments, one or more components of controller 106 may be located in a cloud, or alternatively in a single location (such as a hospital server room) or distributed locations. Components of controller 106 may be in an integrated device, or distributed at different locations but communicate with each other through a network (not shown).

Communication interface 202 may receive data from virtual-experience server 102, wearable-robotic device 108, etc. via network 120, communication cables, a Wireless Local Area Network (WLAN), a Wide Area Network (WAN), wireless networks such as radio waves, a cellular network, and/or a local or short-range wireless network (e.g., Bluetooth™), or other communication methods. In some embodiments, communication interface 202 can be an integrated services digital network (ISDN) card, cable modem, satellite modem, or a modem to provide a data communication connection. As another example, communication interface 202 can be a local area network (LAN) card to provide a data communication connection to a compatible LAN. Wireless links can also be implemented by communication interface 202. In such an implementation, communication interface 202 can send and receive electrical, electromagnetic or optical signals that carry digital data streams representing various types of information via a network.

Consistent with some embodiments, communication interface 202 may receive virtual-experience information 201 (e.g., initial weight of a jar of water, weight of sand per volume, an angular degree threshold value, deformation characteristics such as stress, strain, elasticity, etc. related to a virtual deformable object, etc.) associated with a selected virtual experience. Memory 206 and/or storage 208 may maintain the virtual-experience information 201.

Processor 204 may be a processing device that includes one or more general processing devices, such as a microprocessor, a central processing unit (CPU), a graphics processing unit (GPU), and the like. More specifically, processor 204 may be a complex instruction set computing (CISC) microprocessor, a reduced instruction set computing (RISC) microprocessor, a very long instruction word (VLIW) microprocessor, a processor running other instruction sets, or a processor that runs a combination of instruction sets. Processor 204 may also be one or more dedicated processing devices such as application specific integrated circuits (ASICs), field programmable gate arrays (FPGAs), digital signal processors (DSPs), system-on-chip (SoCs), and the like.

Processor 204 may be configured as a separate processor module dedicated to performing computations related to the change in weight or shape of virtual objects indicated in the virtual-experience information 201. Alternatively, processor 204 may be configured as a shared processor module for performing other functions. Processor 204 may be communicatively coupled to memory 206 and/or storage 208 and configured to execute the computer-executable instructions stored thereon.

Memory 206 and storage 208 may include any appropriate type of mass storage provided to store any type of information that processor 204 may need to operate. Memory 206 and storage 208 may be a volatile or non-volatile, magnetic, semiconductor, tape, optical, removable, non-removable, or other type of storage device or tangible (e.g., non-transitory) computer-readable medium including, but not limited to, a read-only memory (ROM), a flash memory, a dynamic random-access memory (RAM), and a static RAM. Memory 206 and/or storage 208 may store one or more computer programs that may be executed by processor 204 to perform fault determination disclosed herein. For example, memory 206 and/or storage 208 may store program(s) that may be executed by processor 204 to calculate the change in weight and/or shape of a virtual object interacted with by a user, and to cause the output of a corresponding physical-feedback response.

Memory 206 and/or storage 208 may further store information and data used by processor 204. For instance, memory 206 and/or storage 208 may store various types of data, such as virtual-experience information 201. Memory 206 and/or storage 208 may also store intermediate data, such as the location and characteristics (e.g., initial weight, the amount an object deforms under various forces, etc.) of virtual objects. Memory 206 and/or storage 208 may update the weight and/or shape (weight distribution) of virtual object(s) as they are being interacted with. The various types of data may be stored permanently, removed periodically, or disregarded immediately after each update to the weight and/or shape of the virtual object.

As shown in FIG. 2, processor 204 includes multiple modules, such as a physical measurement unit 240, a decision unit 242, and a simulation unit 244, etc. These modules (and any corresponding sub-modules or sub-units) can be hardware units (e.g., portions of an integrated circuit) of processor 204 designed for use with other components or software units implemented by processor 204 through executing at least part of a program. The program may be stored on a computer-readable medium, and when executed by processor 204, it may perform one or more functions. Although FIG. 2 shows units 240, 242, and 244 all within one processor 204, it is contemplated that these units may be distributed among multiple processors located near or remotely with each other. According to the present disclosure, the number and type of these modules are not limited to those shown in FIG. 2.

In some embodiments, units 240, 242, and 244 of FIG. 2 may execute computer instructions to determine a change in weight and/or shape of a virtual object interacted with by a user via a wearable-robotic device, and to cause the wearable-robotic device to output a feedback response corresponding to the calculated change in the virtual object's weight and/or shape.

In some embodiments, referring to FIGS. 1, 2, and 3, client device 104 may initiate a virtual experience associated with wearable-robotic device 108. A user may select the virtual experience from a set of virtual experiences, which are accessible from virtual-experience server 102 via client device 104 (or another client device). The virtual experience may include, among others, a virtual object 304 and an avatar 308 associated with user 302. In the example depicted in FIG. 3, virtual object 304 is a jar of water, and the game's objective is to pour water from the jar into a glass. However, in other examples, virtual object 304 may be sand, and the point of the game may be to pick up a handful of sand. In still other examples, virtual object 304 may include a deformable object (e.g., such as a squeeze ball), and the goal is to squeeze the ball. However, virtual object 304 is not limited to these examples and may include any virtual object that can undergo a change in weight and/or shape without departing from the scope of the present disclosure. Moreover, the objective of the virtual experience is not limited to mobility rehabilitation gaming, and may include any other types of games that incorporate wearable-robotic device into the overall system. For example, such games can be for leisure, educational, or athletic training purposes.

Still referring to FIGS. 2 and 3, physical measurement unit 240 may determine the initial weight of virtual object 304 (e.g., the weight of the jar of water) based on the virtual-experience information 201. Decision unit 242 may determine an interaction with virtual object 304 by avatar 308 causes a change in one or more of a weight or a shape of the virtual object 304. For example, when user 302 turns the exoskeleton attached to her arm, torque sensors (attached to the joints of wearable-robotic device 108) may send torque signals 203 and encoder sensors (also attached to joints of the wearable-robotic device 108) may send position signals 205 to controller 106. Then, decision unit 242 may determine the change in the weight and/or shape of virtual object 304 based on torque signals 203 and position signals 205.

In some implementations, referring to FIGS. 2 and 3, decision unit 242 may determine an angular degree of the interaction with virtual object 304 based on torque signals 203. The angular degree may refer to the amount that avatar 308 turns when user 302 mimics a pouring motion. Decision unit 242 may compare the determined angular degree with the angular degree threshold value included in virtual-experience information 201. When the angular degree meets or exceeds the threshold value, decision unit 242 may determine the change in the weight and/or the shape of virtual object 304 based on torque signals 203 and position signals 205. Decision unit 242 may send data related to the change in the weight and/or shape of virtual object 304 to physical measurement unit 240, and data related to the change in distance and/or angular degree to simulation unit 244.

Referring to FIGS. 2 and 3, physical measurement unit 240 may determine a physical-feedback response of wearable-robotic device based on the new weight and/or shape (amount of deformation) of virtual object 304 indicated in the data from decision unit 242. For instance, the change in the weight and/or shape of virtual object 304 may be correlated with a change in the amount of force (e.g., a change in feedback response) output by wearable-robotic device 108. Physical measurement unit 240 may generate a feedback-response signal corresponding to the change in the amount of force. Communication interface 202 may send the feedback-response signal to feedback motor 306. Feedback motor 306 may cause the actuators of wearable-robotic device 108 to output the change in force or other types of feedback response(s). Non-limiting examples of feedback motor 306 include one or more of, e.g., a haptic feedback motor (a dynamic pressure response), a vibrotactile feedback motor (a dynamic vibration response), a thermal feedback motor (dynamic heat response), or an electro-tactile feedback motor (dynamic electro-stimulation).

In some implementations, referring to FIGS. 2 and 3, simulation unit 244 may determine how to render and simulate the change in the weight and/or shape of virtual object 304 indicated in the data received from decision unit 242. For instance, the change(s) in distance and/or angular degree (indicated in the data received from decision unit 242) may be correlated with changes in distance and angular degree of the displayed avatar 308. Moreover, the change(s) in distance and/or angular degree may be correlated with changes in the weight and/or shape of virtual object 304. Simulation unit 244 may send information related to the changes in distance and angular degree of avatar 308, and changes in distance, angular degree, and weight and/or shape of virtual object 304 to client device 104 for simulation and rendering.

In some examples, referring to FIGS. 2 and 3, physical measurement unit 240 and simulation unit 244 may perform parallel processing of the data received from decision unit 242. Consequently, the simulated rendering of the movement of avatar 308 may be output concurrent with the output of the physical-feedback response by the wearable-robotic device 108/feedback motor 306 to enhance the realism of the virtual experience.

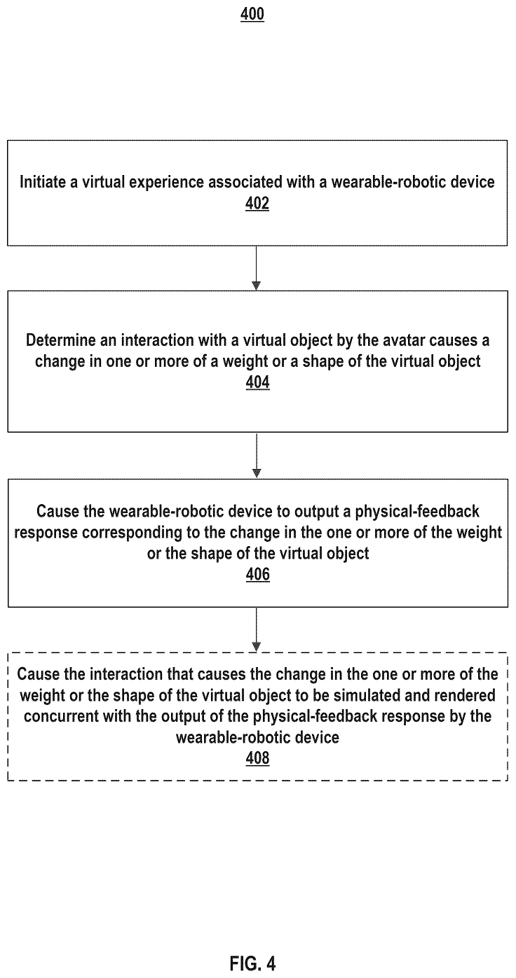

FIG. 4 is a flowchart of an exemplary method 400 of VR gaming performed by an exoskeleton system (such as the one illustrated in FIG. 1), according to embodiments of the disclosure. Method 400 may be performed by a device, e.g., such as virtual-experience server 102, client device 104, controller 106, wearable-robotic device 108, processor 204, physical measurement unit 240, decision unit 242, simulation unit 244, and/or feedback motor 306, just to name a few. Method 400 may include operations 402-408, as described below. It is to be appreciated that some of the steps may be optional, and some of the steps may be performed simultaneously, or in a different order than shown in FIG. 4.

Referring to FIG. 4, at 402, the device may initiate a virtual experience associated with a wearable-robotic device. In some implementations, the virtual experience may include an avatar associated with the user. In some implementations, the virtual experience may be a rehabilitation game. In some implementations, the virtual experience may be a leisure game. For example, referring to FIGS. 1, 2, and 3, client device 104 may initiate a virtual experience associated with wearable-robotic device 108. A user may select the virtual experience from a set of virtual experiences, which are accessible from virtual-experience server 102 via client device 104 (or another client device). The virtual experience may include, among others, a virtual object 304 and an avatar 308 associated with user 302.

At 404, the device may determine an interaction with a virtual object by the avatar causes a change in one or more of a weight or a shape of the virtual object. In some implementations, to determine the interaction with the virtual object by the avatar causes the change in one or more of the weight or the shape of the virtual object, the device may receive a set of torque signals from a first set of sensors coupled to the wearable-robotic device when the avatar interacts with the virtual object. In some implementations, to determine the interaction with the virtual object by the avatar causes the change in one or more of the weight or the shape of the virtual object, the device may receive a set of position signals from a second set of sensors coupled to the wearable-robotic device when the avatar interacts with the virtual object. In some implementations, to determine the interaction with the virtual object by the avatar causes the change in one or more of the weight or the shape of the virtual object, the device may determine an angular degree of the interaction with the virtual object based on first set of torque signals. In some implementations, to determine the interaction with the virtual object by the avatar causes the change in one or more of the weight or the shape of the virtual object, the device may, in response to the angular degree meeting a threshold value, determining, by the processor, the change in the one or more of the weight or the shape of the virtual object based on the set of torque signals and the set of position signals. In some implementations, the virtual object may be a container of liquid. In some implementations, the interaction with the virtual object may cause the liquid to drain or be poured from the container. In some implementations, the virtual object may be a granular material. In some implementations, the interaction with the virtual object may cause the granular material to slip between fingers of the avatar. For example, referring to FIGS. 2 and 3, decision unit 242 may determine an interaction with virtual object 304 by avatar 308 causes a change in one or more of a weight or a shape of the virtual object 304. For example, when user 302 turns the exoskeleton attached to her arm, torque sensors (attached to the joints of wearable-robotic device 108) may send torque signals 203 and encoder sensors (also attached to joints of the wearable-robotic device 108) may send position signals 205 to controller 106. Then, decision unit 242 may determine the change in the weight and/or shape of virtual object 304 based on torque signals 203 and position signals 205. For instance, decision unit 242 may determine an angular degree of the interaction with virtual object 304 based on torque signals 203. The angular degree may refer to the amount that avatar 308 turns when user 302 mimics a pouring motion. Decision unit 242 may compare the determined angular degree with the angular degree threshold value included in virtual-experience information 201. When the angular degree meets or exceeds the threshold value, decision unit 242 may determine the change in the weight and/or the shape of virtual object 304 based on torque signals 203 and position signals 205.

At 406, the device may cause the wearable-robotic device to output a physical-feedback response corresponding to the change in the one or more of the weight or the shape of the virtual object. In some implementations, to cause the wearable-robotic device to output a physical-feedback response corresponding to the change in the one or more of the weight or the shape of the virtual object, the device may determine an amount of force to exert by a feedback motor coupled to the wearable-robotic device based on the change in the one or more of the weight or the shape of the virtual object. In some implementations, to cause the wearable-robotic device to output a physical-feedback response corresponding to the change in the one or more of the weight or the shape of the virtual object, the device may send a physical-feedback response signal corresponding to the amount of force to exert to the feedback motor. In some implementations, the feedback motor may include one or more of a haptic feedback motor, a vibrotactile feedback motor, a thermal feedback motor, or an electro-tactile feedback motor. For example, referring to FIGS. 2 and 3, physical measurement unit 240 may determine a physical-feedback response of wearable-robotic device based on the new weight and/or shape (amount of deformation) of virtual object 304 indicated in the data from decision unit 242. For instance, the change in the weight and/or shape of virtual object 304 may be correlated with a change in the amount of force (e.g., a change in feedback response) output by wearable-robotic device 108. Physical measurement unit 240 may generate a feedback-response signal corresponding to the change in the amount of force. Communication interface 202 may send the feedback-response signal to feedback motor 306. Feedback motor 306 may cause the actuators of wearable-robotic device 108 to output the change in force.

At 408, the device may cause the interaction that causes the change in the one or more of the weight or the shape of the virtual object to be simulated and rendered concurrent with the output of the physical-feedback response by the wearable-robotic device. For example, referring to FIGS. 2 and 3, simulation unit 244 may determine how to render and simulate the change in the weight and/or shape of virtual object 304 indicated in the data received from decision unit 242. For instance, the change(s) in distance and/or angular degree (indicated in the data received from decision unit 242) may be correlated with changes in distance and angular degree of the displayed avatar 308. Moreover, the change(s) in distance and/or angular degree may be correlated with changes in the weight and/or shape of virtual object 304. Simulation unit 244 may send information related to the changes in distance and angular degree of avatar 308, and changes in distance, angular degree, and weight and/or shape of virtual object 304 to client device 104 for simulation and rendering.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

By enabling a physical-feedback response to virtual objects that change their weight and shape dynamically, the exoskeleton system of the present disclosure provides an immersive experience for a user practicing daily activities like serving water, drinking water, playing with sand, among others. This safe rehabilitation of realistic tasks may improve user rehabilitation by training with deformable and changing weight virtual elements. The same or similar techniques can be used to increase the realism and improve the immersive experience of leisure games.

It will be apparent to those skilled in the art that various modifications and variations can be made to the disclosed system and related methods. Other embodiments will be apparent to those skilled in the art from consideration of the specification and practice of the disclosed system and related methods. For example, the disclosed techniques and embodiments can be adapted to other types of gaming applications, beyond mobility rehabilitation gaming, as long as they incorporate a wearable-robotic device into the overall system. These other types of gaming systems can be for leisure, educational, athletic training or other purposes. For example, interactive gaming systems can be developed for students to understand principles of physics, or for athletes to train specific groups of muscles.

It is intended that the specification and examples be considered as exemplary only, with a true scope being indicated by the following claims and their equivalents.

What is claimed is:

1. A method of virtual-reality (VR) gaming, comprising:
initiating, by a processor, a virtual experience associated with a wearable-robotic device coupled to a user, the virtual experience including an avatar associated with the user;
determining, by the processor, an interaction with a virtual object by the avatar causes a change in one or more of a weight or a shape of the virtual object; and
causing, by the processor, the wearable-robotic device to output a physical-feedback response corresponding to the change in the one or more of the weight or the shape of the virtual object.

2. The method of claim 1, further comprising:
causing, by the processor, the interaction that causes the change in the one or more of the weight or the shape of the virtual object to be simulated and rendered concurrent with the output of the physical-feedback response by the wearable-robotic device.

3. The method of claim 1, wherein the determining, by the processor, the interaction with the virtual object by the avatar causes the change in one or more of the weight or the shape of the virtual object comprises:
receiving, by the processor, a set of torque signals from a first set of sensors coupled to the wearable-robotic device when the avatar interacts with the virtual object;
receiving, by the processor, a set of position signals from a second set of sensors coupled to the wearable-robotic device when the avatar interacts with the virtual object;
determining, by the processor, an angular degree of the interaction with the virtual object based on first set of torque signals; and
in response to the angular degree meeting a threshold value, determining, by the processor, the change in the one or more of the weight or the shape of the virtual object based on the set of torque signals and the set of position signals.

4. The method of claim 1, wherein the causing, by the processor, wearable-robotic device to output a physical-feedback response corresponding to the change in the one or more of the weight or the shape of the virtual object comprises:
determining, by the processor, an amount of force to exert by a feedback motor coupled to the wearable-robotic device based on the change in the one or more of the weight or the shape of the virtual object; and
sending, by the processor, a physical-feedback response signal corresponding to the amount of force to exert to the feedback motor.

5. The method of claim 4, wherein the feedback motor comprises one or more of a haptic feedback motor, a vibrotactile feedback motor, a thermal feedback motor, or an electro-tactile feedback motor.

6. The method of claim 1, wherein:
the virtual object is a container of liquid, and
the interaction with the virtual object causes the liquid to drain or be poured from the container.

7. The method of claim 1, wherein:
the virtual object is a granular material, and
the interaction with the virtual object causes the granular material to slip between fingers of the avatar.

8. The method of claim 1, wherein the virtual experience is a rehabilitation game.

9. An apparatus for virtual-reality (VR) gaming, comprising:
a wearable-robotic device coupled to a user; and
a processor configured to:
initiate a virtual experience associated with the wearable-robotic device, the virtual experience including an avatar associated with the user;
determine an interaction with a virtual object by the avatar causes a change in one or more of a weight or a shape of the virtual object; and
cause the wearable-robotic device to output a physical-feedback response corresponding to the change in the one or more of the weight or the shape of the virtual object.

10. The apparatus of claim 9, further comprising a display device, wherein the processor is further configured to:
cause the interaction that causes the change in the one or more of the weight or the shape of the virtual object to be simulated and rendered concurrent with the output of the physical-feedback response by the wearable-robotic device.

11. The apparatus of claim 9, wherein, to determine the interaction with the virtual object by the avatar causes the change in one or more of the weight or the shape of the virtual object, the processor is configured to:
receive a set of torque signals from a first set of sensors coupled to the wearable-robotic device when the avatar interacts with the virtual object;
receive a set of position signals from a second set of sensors coupled to the wearable-robotic device when the avatar interacts with the virtual object;
determine an angular degree of the interaction with the virtual object based on first set of torque signals; and
in response to the angular degree meeting a threshold value, determine the change in the one or more of the weight or the shape of the virtual object based on the set of torque signals and the set of position signals.

12. The apparatus of claim 9, wherein, to cause the wearable-robotic device to output a physical-feedback response corresponding to the change in the one or more of the weight or the shape of the virtual object, the processor is configured to:
determine an amount of force to exert by a feedback motor coupled to the wearable-robotic device based on the change in the one or more of the weight or the shape of the virtual object; and
send a physical-feedback response signal corresponding to the amount of force to exert to the feedback motor.

13. The apparatus of claim 12, wherein the feedback motor comprises one or more of a haptic feedback motor, a vibrotactile feedback motor, a thermal feedback motor, or an electro-tactile feedback motor.

14. The apparatus of claim 9, wherein:
the virtual object is a container of liquid, and the interaction with the virtual object causes the liquid to drain or be poured from the container, or
the virtual object is a granular material, and the interaction with the virtual object causes the granular material to slip between fingers of the avatar.

15. A non-transitory computer-readable medium storing instructions, which when executed by a processor, cause the processor to:, comprising:
initiate a virtual experience associated with a wearable-robotic device, the virtual experience including an avatar associated with a user;
determine an interaction with a virtual object by the avatar causes a change in one or more of a weight or a shape of the virtual object; and
cause the wearable-robotic device to output a physical-feedback response corresponding to the change in the one or more of the weight or the shape of the virtual object.

16. The non-transitory computer-readable medium of claim 15, wherein the instructions, which when executed by the processor, further cause the processor to:
cause the interaction that causes the change in the one or more of the weight or the shape of the virtual object to be simulated and rendered concurrent with the output of the physical-feedback response by the wearable-robotic device.

17. The non-transitory computer-readable medium of claim 15, wherein, to determine the interaction with the virtual object by the avatar causes the change in one or more of the weight or the shape of the virtual object, the instructions, which when executed by the processor, further cause the processor to:
receive a set of torque signals from a first set of sensors coupled to the wearable-robotic device when the avatar interacts with the virtual object;
receive a set of position signals from a second set of sensors coupled to the wearable-robotic device when the avatar interacts with the virtual object;
determine an angular degree of the interaction with the virtual object based on first set of torque signals; and
in response to the angular degree meeting a threshold value, determine the change in the one or more of the weight or the shape of the virtual object based on the set of torque signals and the set of position signals.

18. The non-transitory computer-readable medium of claim 15, wherein, to cause the wearable-robotic device to output a physical-feedback response corresponding to the change in the one or more of the weight or the shape of the virtual object, the instructions, which when executed by the processor, further cause the processor to:
determine an amount of force to exert by a feedback motor coupled to the wearable-robotic device based on the change in the one or more of the weight or the shape of the virtual object; and
send a physical-feedback response signal corresponding to the amount of force to exert to the feedback motor.

19. The non-transitory computer-readable medium of claim 18, wherein the feedback motor comprises one or more of a haptic feedback motor, a vibrotactile feedback motor, a thermal feedback motor, or an electro-tactile feedback motor.

20. The non-transitory computer-readable medium of claim 15, wherein:
the virtual object is a container of liquid, and the interaction with the virtual object causes the liquid to drain or be poured from the container, or
the virtual object is a granular material, and the interaction with the virtual object causes the granular material to slip between fingers of the avatar.
